(19) United States
(12) Patent Application Publication
(10) Pub. No.: US 2011/0068495 A1
(43) Pub. Date: Mar. 24, 2011

(54) METHOD FOR PROCESSING FILMS ATTACHED ON TWO SIDES OF A GLASS SUBSTRATE

(75) Inventor: Wen-Chu Chen, Taichung City (TW)

(73) Assignee: Gallant Precision Machining Co., Ltd., Hsinchu (TW)

(21) Appl. No.: 12/796,342

(22) Filed: Jun. 8, 2010

(30) Foreign Application Priority Data
Sep. 18, 2009 (TW) 098131470

(51) Int. Cl. B29D 11/00; B29C 35/08

(52) U.S. Cl. 264/1.37; 264/400

(57) ABSTRACT

A method for processing films attached on two sides of a glass substrate is disclosed, which comprises the steps of: providing a laser machining device capable of performing a patterning process whereas the transmission of a laser beam for the patterning process is below 50%; providing a glass substrate having its two sides being attached by films in respective; and exciting the laser machining device for projecting the laser beam onto the films of the glass substrate for patterning the films with predefined patterns.

### FIELD OF THE INVENTION

The present invention relates to a method for processing films attached on two sides of a glass substrate, and more particularly, to a process for patterning films attached on two sides of a glass substrate by the projection of a low transmission laser beam.

### BACKGROUND OF THE INVENTION

Generally, glass substrates used for fabricating photo-electric devices are coated with all kinds of films on their two sides for achieving specific electrical or optical effects.

For instance, there are certain glass substrates that are formed by having their two sides to be sputtered or evaporated with conductive thin films. The conductive thin films can be categorized into two groups, which are the transparent conductive thin films and opaque conductive thin films. It is known that the group of the transparent conductive thin films includes: indium tin oxide (ITO) thin films, ZnO thin films, Al-doped ZnO (AZO) thin films, and so on; while the group of the opaque conductive thin films includes: Mo thin films, CdTe thin films, CIGS thin films, poly-Si thin films, and so on. In addition to the conductive thin film that can be a layer of coating formed on the glass substrate, the thin films can be optical thin films that are adhered on the glass substrate, such as polarizers, PET thin films. Moreover, the films to be formed on the two sides of the glass substrate also can be insulation layers or adhesive layers that are coated on the glass substrate.

Nevertheless, all those different thin films that are attached onto two sides of a glass substrate should be processed into predefined circuits or patterned into predefined patterns so as to achieved different effects as required.

Taking a touch panel for example, it is fabricated by coating ITO circuits or patterns on a glass substrate for enabling any current variation in the ITO circuits that is caused by the presence of a touch to be detected by sensors, and using the sensors, the parameters relating to the detected current variation are converted into digital signals and sent to a controller to be used in a calculation for obtaining information relating the location of the touch point or area, or even the coordinates of the moving trajectory of the touch. Thereafter, the content of a human-machine interface displayed on the touch panel can be adjusted accordingly for refreshing the display of the touch panel.

Conventionally, the coating of ITO on a glass substrate can be divided into single-sided coating and double-sided coating. The single-sided coating is performed by having only one side of the glass substrate to be coated by ITO and then enabling the ITO coating to be patterned by etching, screen printing or laser patterning for patterning the ITO coating into a designated circuit layout or pattern.

Although the use of chemicals for etching ITO coating can facilitate mass production, it can also create server pollution problem. On the other hand, although the use of screen printing is advantageous in its high production throughput, it can have trouble when the ITO circuits or ITO patterns to be formed on the substrate are change even slightly since it will required to redesign and change the screen entirely, not to mention that the screen printing can not produce fine-pitch circuit layout. Moreover, although the laser patterning is advantageous in that: it is flexible enough for dealing with any design change in ITO circuits or patterns and also it is capable of producing circuits as narrow as 10 um, it is inferior in production throughput.

For double-sided coating, the substrate is first being provided to have both its two sides being coated by an ITO material, and then it is processed by an etching means, a screen printing means or a laser patterning means for removing portions of the ITO material from the substrate according to a predefined design so as to form a specific pattern or conductive circuit on the substrate.

It is noted that for the patterning using the etching means and the screen printing means, the process can be performed without any modification no matter it is for double-sided coating or for single-sided coating. However, it is totally different for the laser patterning means since it can be very problematic for double-sided coating using the laser patterning means.

Clearly, the double-sided coating is performed by having two sides of the glass substrate to be coated by ITO while enabling the two ITO coatings to be formed with different circuit layouts or patterns. Nevertheless, if a laser patterning means is used for patterning the ITO coating that is coated on one side of the glass substrate, the laser beam can easily penetrate the glass substrate and thus cause damage to the ITO coating on opposite side of the glass substrate. Consequently, the ITO coatings on both sides of the glass substrate may be damaged.

It is noted that as there are a variety of films, other than ITO coatings, capable of being attached onto glass substrates, all those other type of films will face the same problems troubling the ITO coatings. For most laser machining devices that are currently available, only the laser beam with a specific wavelength that is characterized by high transmission efficiency is used for patterning films attached on glass substrates. That is why the laser beam can easily penetrate the glass substrate and thus cause damage to the ITO coating on opposite side of the glass substrate.

Especially, in response to the recent trend that the recent electronic devices are becoming lighter and thinner, the glass substrates used thereby are also becoming thinner whereas the films formed respectively on two sided of a thinner glass substrate can be more vulnerable to laser patterning as the laser beam can penetrate the thinner glass substrate even more easily.

Therefore, it is in need of an improved method for processing films attached on two sides of a glass substrate.

### SUMMARY OF THE INVENTION

In view of the disadvantages of prior art, the primary object of the present invention is to provide a method for performing a double-sided patterning on films attached on two sides of a glass substrate without causing any unwanted damage to the films whereas the double-sided patterning is performed using a laser beam whose transmission is below 50%.

To achieve the above object, the present invention provides a method for processing films attached on two sides of a glass substrate, which comprises the steps of: providing a laser machining device capable of performing a patterning process by the projection of a laser beam while enabling the transmission of the laser beam for the patterning process to be below 50%; providing a glass substrate having its two sides being attached by films in respective; and exciting the laser machining device for projecting the laser beam onto the films of the glass substrate for patterning the films with predefined patterns.

As the transmission of the laser beam excited in the laser machining device is below 50% and the glass substrate is moving relative to the projection of the laser beam during the patterning of films on the glass substrate, the energy of the projection of the laser beam on one side of the glass substrate is not intense enough to penetrate the glass substrate for causing any damage to the film on opposite side of the glass substrate, and vice versa.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting the steps of a method for processing films attached on two sides of a glass substrate according to an embodiment of the invention.

FIG. 2 is a cross sectional view of a glass substrate with films attached respectively on its two sides.

FIG. 3 is a chart demonstrating the transmissions of laser beams with different wavelength propagating through three different glasses.

FIG. 4 is a chart demonstrating the transmissions of laser beams in short wavelength range that is propagating through a glass substrate.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

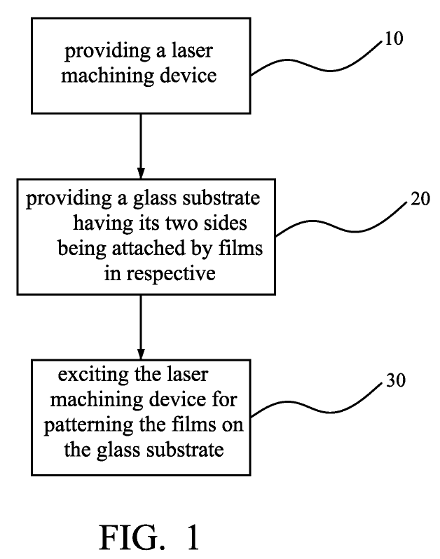

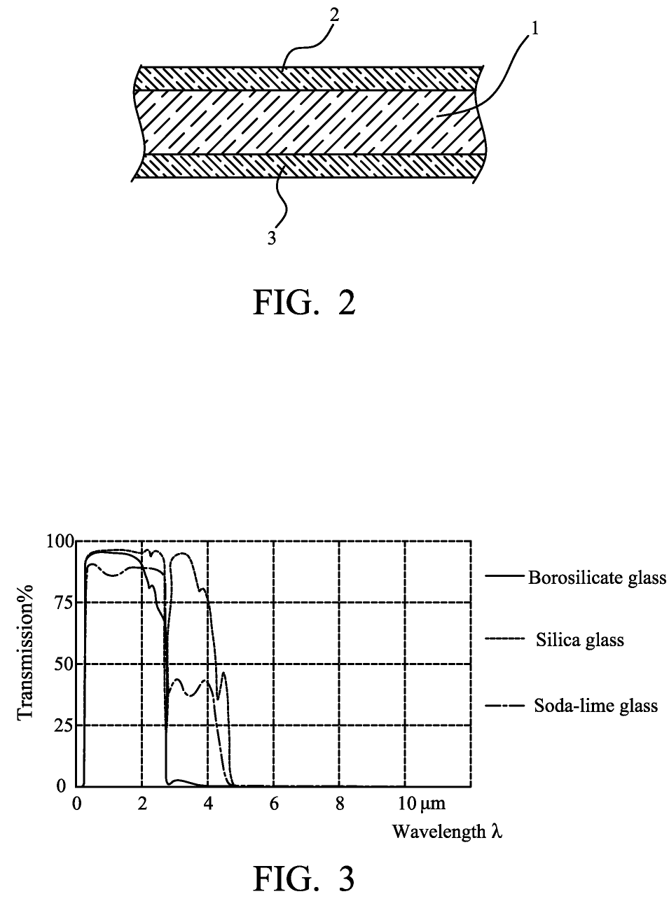

Please refer to FIG. 1 to FIG. 4, which are a flow chart depicting the steps of a method for processing films attached on two sides of a glass substrate according to an embodiment of the invention; a cross sectional view of a glass substrate with films attached respectively on its two sides; and a chart demonstrating the transmissions of laser beams with different wavelength propagating through three different glasses; and a chart demonstrating the transmissions of laser beams in short wavelength range that is propagating through a glass substrate.

As shown in FIG. 1, the method for processing films attached on two sides of a glass substrate at least comprises the following steps:
Step 10: providing a laser machining device capable of performing a patterning process upon a glass substrate by the projection of a laser beam while enabling the transmission of the laser beam for the patterning process to be below 50% and to be adjusted and selected according to the thickness of a glass substrate on which as well as the materials of the films attached on the glass substrate.
Step 20: providing a substrate 1 being made of glass and having its two sides being attached by films in respective while enabling the thickness of the glass substrate 1 to be ranged between 5 mm and 0.2 mm.
Step 30: exciting the laser machining device for projecting the laser beam onto the films 2, 3 of the glass substrate 1 for patterning the films with predefined patterns.

In step 10, when the transmission of the laser beam is selected and adjusted according to the materials of the attached films and if the films are opaque conductive thin films such as Mo thin films, CdTe thin films, CIGS thin films, poly-Si thin films, etc., the laser beams whose transmissions are below 50% or whose wavelengths are smaller than 355 nm or larger than 2.5 um, are selected to be used for the patterning process; on the other hand, if the films are transparent conductive thin films such as indium tin oxide (ITO) thin films, ZnO thin films, Al-doped ZnO (AZO) thin films, optical thin films, etc., the laser beams whose transmissions are below 20% or whose wavelengths are smaller than 300 nm or larger than 2.8 um, are selected to be used for the patterning process. Nevertheless, for those insulation layers or adhesive layers, the laser beams whose transmissions are below 5% or whose wavelengths are smaller than 266 nm or larger than 4.5 um, are selected to be used for the patterning process.

In addition, when the transmission of the laser beam is selected and adjusted according to the thickness of the glass substrate while the thickness is ranged between 5 mm and 3.2 mm, the laser beams whose transmissions are below 50% or whose wavelengths are smaller than 355 nm or larger than 2.5 um, are selected to be used for the patterning process; however, when the thickness of the glass substrate is ranged between 3.2 mm and 1 mm, the laser beams whose transmissions are below 20% or whose wavelengths are smaller than 300 nm or larger than 2.8 um, are selected to be used for the patterning process. In addition, when the thickness of the glass substrate is smaller than 1 mm, the laser beams whose transmissions are below 5% or whose wavelengths are smaller than 266 nm or larger than 4.5 um, are selected to be used for the patterning process.

In step 20, when the glass substrate 1 is to be used for the substrate of a photovoltaic panel, the thickness of the glass substrate 1 is preferred to be ranged between 5 mm and 3.2 mm; and when the glass substrate 1 is to be used for the substrate of a TFT-LCD panel, the thickness of the glass substrate 1 is preferred to be ranged between 1.5 mm and 0.5 mm; and when the glass substrate 1 is to be used for the substrate of a touch panel, the thickness of the glass substrate 1 is preferred to be ranged between 1.1 mm and 0.2 mm. It is noted that the films 2 and 3 that are attached on two sides of the glass substrate 1 can be transparent conductive thin films, such as indium tin oxide (ITO) thin films, ZnO thin films, Al-doped ZnO (AZO) thin films, etc., or can be opaque conductive thin films, such as Mo thin films, CdTe thin films, CIGS thin films, poly-Si thin films, etc. Moreover, the films can be optical thin films, such as polarizers or PET films; or even can insulation layers or adhesive layers that are coated on the glass substrate 1.

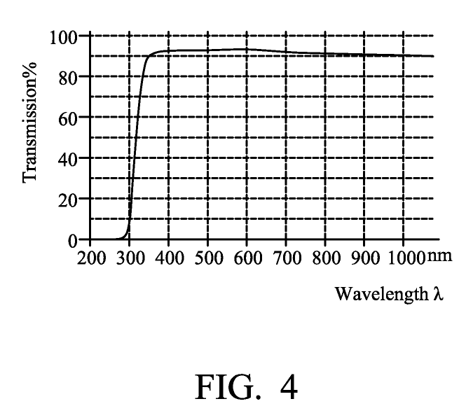

It known to those skilled in the art that the transmissions of laser beams to different glass substrates will be different according to their wavelengths and the type of glass substrate where they are propagating through, as shown in FIG. 3. Moreover, the transmissions of different laser beams in short wavelength range that are propagating through a glass substrate are shown in FIG. 4. As shown in FIG. 3, the transmission of laser beams in short wavelength range as well as the laser beams in the long wavelength range are all comparatively smaller, i.e. below 50%, but for those laser beams whose wavelengths are smaller than 355 nm or larger than 2.5 um, their transmissions will be higher than 50%, or even achieve 95%. In most convention laser machining devices, the laser beams used for film patterning are those whose wavelengths are ranged between 355 nm and 2.5 um, and therefore, the projection of such laser beam on one side of the glass substrate is most likely to penetrate the glass substrate for causing damage to the film on opposite side of the glass substrate.

From FIG. 3 and FIG. 4, it is noted that for those laser beams whose wavelengths are smaller than 355 nm or larger than 2.5 um, the transmissions thereof will be lower than 50%. As the transmission of the laser beam excited in the laser machining device of the present invention is below 50% and the glass substrate is moving relative to the projection of the laser beam during the patterning of films on the glass substrate, the energy of the projection of the laser beam on one side of the glass substrate is not intense enough to penetrate the glass substrate for causing any damage to the film on opposite side of the glass substrate, and vice versa.

Experimentally, the laser beam whose transmission is below 5% as well as those whose wavelengths are ranged between 266 nm and 188 nm are sufficient enough to be used for patterning ITO films formed on two sides of a 0.4 mm glass substrate without causing any unwanted damages.

As the aforesaid experiment is performed on a glass substrate used for making modern touch panels, the glass substrate with 0.4 mm in thickness is the thinnest glass substrate available today; and it is proven that the laser beam whose transmission is below 5% as well as those whose wavelengths are ranged between 266 nm and 188 nm are sufficient enough for patterning films 2, 3 on such glass substrate 1. However, for those thicker glass substrates, the laser beams with higher transmission, i.e. high than 5% but lower than 50%, are selected for the patterning process of the present invention. Nevertheless, laser beams of different transmissions (must be lower than 50%) can be selected and used in the patterning process according to the material characteristic of the films that are to be patterned. The aforesaid patterning methods all are capable of patterning films 2, 3 on such glass substrate 1 without causing any damage to any films 2, 3.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for processing films attached on two sides of a glass substrate, at least comprising the steps of:
providing a laser machining device capable of performing a patterning process by the projection of a laser beam while enabling the transmission of the laser beam for the patterning process to be below 50%;
providing a glass substrate having its two sides being attached by films in respective; and
exciting the laser machining device for projecting the laser beam onto the films of the glass substrate for patterning the same.

2. The method of claim 1, wherein the transmission of the laser beam for the patterning process is below 20%.

3. The method of claim 1, wherein the transmission of the laser beam for the patterning process is below 5%.

4. The method of claim 1, wherein each of the film is a conductive thin film.

5. The method of claim 4, wherein the conductive thin film is a film selected from the group consisting of: an indium tin oxide (ITO) thin film, a ZnO thin film, and an Al-doped ZnO (AZO) thin film.

6. The method of claim 4, wherein the conductive thin film is a film selected from the group consisting of: a Mo thin film, a CdTe thin film, a CIGS thin film, and a poly-Si thin film.

7. The method of claim 1, wherein each of the films is an optical thin film.

8. The method of claim 7, wherein the optical thin film is a film selected from the group consisting of: a polarizer, and a PET thin film.

9. The method of claim 1, wherein each of the films is an insulation layer or adhesive layer that are coated on the glass substrate by a coating process.

10. The method of claim 1, wherein the thickness of the glass substrate is not larger than 5 mm.

11. The method of claim 1, wherein the thickness of the glass substrate is ranged between 5 mm and 3.2 mm.

12. The method of claim 1, wherein the thickness of the glass substrate is ranged between 1.5 mm and 0.5 mm.

13. The method of claim 1, wherein the thickness of the glass substrate is ranged between 1.1 mm and 0.2 mm.

14. A method for processing films attached on two sides of a glass substrate, at least comprising the steps of:
providing a laser machining device capable of performing a patterning process using a laser beam while defining the wavelength of the laser beam to be smaller than 355 nm or larger than 2.5 um;
providing a glass substrate having its two sides being attached by films in respective; and
exciting the laser machining device for projecting the laser beam onto the films of the glass substrate for patterning the same.

15. The method of claim 14, wherein the laser beam used in the patterning process is a laser beam whose wavelength is not larger than 300 nm.

16. The method of claim 14, wherein the laser beam used in the patterning process is a laser beam whose wavelength is larger than 2.8 um.

17. The method of claim 14, wherein the laser beam used in the patterning process is a laser beam whose wavelength is not larger than 266 nm.

18. The method of claim 14, wherein the laser beam used in the patterning process is a laser beam whose wavelength is larger than 4.5 um.

19. The method of claim 14, wherein the laser beam used in the patterning process is a laser beam whose wavelength is ranged between 266 nm and 188 nm.

20. The method of claim 14, wherein each of the film is a conductive thin film.

21. The method of claim 20, wherein the conductive thin film is a film selected from the group consisting of: an indium tin oxide (ITO) thin film, a ZnO thin film, and an Al-doped ZnO (AZO) thin film.

22. The method of claim 20, wherein the conductive thin film is a film selected from the group consisting of: a Mo thin film, a CdTe thin film, a CIGS thin film, and a poly-Si thin film.

23. The method of claim 14, wherein each of the films is an optical thin film.

24. The method of claim 23, wherein the optical thin film is a film selected from the group consisting of: a polarizer, and a PET thin film.

25. The method of claim 14, wherein each of the films is an insulation layer or adhesive layer that are coated on the glass substrate by a coating process.

26. The method of claim 14, wherein the thickness of the glass substrate is not larger than 5 mm.

27. The method of claim 14, wherein the thickness of the glass substrate is ranged between 5 mm and 3.2 mm.

28. The method of claim 14, wherein the thickness of the glass substrate is ranged between 1.5 mm and 0.5 mm.

29. The method of claim 14, wherein the thickness of the glass substrate is ranged between 1.1 mm and 0.2 mm.
